(19) United States
(12) Patent Application Publication
(10) Pub. No.: US 2006/0173964 A1
(43) Pub. Date: Aug. 3, 2006

(54) Communication terminal device and method for controlling same

(75) Inventors: Junichi Oohama, Tokyo (JP); Hiroshi Kawano, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/236,467

(22) Filed: Sep. 27, 2005

(30) Foreign Application Priority Data
Jan. 28, 2005 (JP) 2005-22236

(51) Int. Cl. G06F 15/16

(52) U.S. Cl. 709/206

(57) ABSTRACT

A communication terminal device and a method for controlling the same which can operate a mail restriction function effectively without increasing a mail address registered for the mail restriction function are provided. The transmission and the reception of the mail is restricted by storing by a domain conversion table a corresponding relationship between an original domain by the automatic address conversion unit and the domain after the conversion, acquiring by the original domain acquiring unit the original domain based on the domain of the mail address converted by the automatic address conversion unit by referring to the domain conversion table, and controlling by the mail transmission and reception control means the transmission and the reception of the mail by comparing the mail address replaced with the domain of the mail address of the transmitting/receiving mail by the original domain acquired by the original domain acquiring unit with the registered mail address.

### CROSS-REFERENCE TO RALATED APPLICAIONS

This application is based upon and claims the benefit of priority from the prior Japanese Patent Application No. 2005-022236, filed on Jan. 28, 2005: the entire contents of which are incorporated herein by reference.

### BACKGROUND OF THE INVENTION

1. Field of the Invention

The present invention relates to a communication terminal device and a method for controlling the communication terminal device, and more particularly to a communication terminal device which eliminates difficulties in a communication terminal device having a mail restriction function that permits transmission/reception of a mail of only a registered mail address and an automatic address converting function that automatically converts a domain of the mail address when transmitting/receiving the mail and a method for controlling the communication terminal device.

2. Description of the Related Art

Recently, of communication terminals, such as portable telephone sets, in order to restrict unnecessary transmission and reception of a mail to and from an unintended party, communication terminals having a mail restriction function for permitting transmission and reception of a mail only to a registered mail address are known.

Japanese Patent Application Publication No. 2004-88753, for example, describes a device having a mail restriction function of the above type. The network facsimile apparatus described in the Japanese Patent Application Publication No. 2004-88753 has a structure in which mail addresses with which transmission and reception are permitted is registered, and mails whose mail address mail is registered are maintained while the mails whose address is not registered are automatically destroyed.

Further, a known communication terminal device such as a portable telephone set has an automatic address converting function that transmits or receives a mail while automatically converting a domain of the mail address of the mail so that order its services are extended into various types.

In the device having the mail restriction function as described in the Japanese Patent Application Publication No. 2004-88753, however, has such inconveniences when employing the above-mentioned automatic address converting function, as follows.

Specifically, since the automatic address converting function automatically converts a mail address in the device according to a form of the mail and the like, even if, for example, the mail address inputted by a user coincides with a mail address registered for performing the mail restriction function, the inputted mail address is, when actually transmitted, converted to another mail address. As a result, the inputted mail address does not coincide with the registered mail address so that there arises a problem that this mail cannot be transmitted to a destination party contrary to the user's intention.

In order to solve this problem, it may be so configured that the mail address for the mail restriction function is registered while considering the automatic conversion of the mail address by the automatic address converting function. However, with such configuration, the number of the mail addresses registered to the mail restriction function would become huge, and it is actually impossible to register all the mail addresses that are expected to be converted by the automatic address converting function.

### SUMMARY OF THE INVENTION

The present invention has been made in view of the above circumstances and provides a communication terminal device and a method for controlling it which can operate a mail restriction function effectively without increasing mail addresses to be registered for the mail restriction function.

According to an aspect of the present invention, a communication terminal device comprises a mail restricting control unit configured to permit transmission and reception of a mail having a registered mail address; an address conversion control unit configured to convert a domain of a mail address of a mail; a domain conversion table configured to store a corresponding relationship between an original domain which is a domain before conversion by the address conversion control unit and a domain converted by the address conversion unit; an original domain acquiring control unit configured to acquire the original domain based on the domain of the mail address converted by the address conversion control unit by referring to the domain conversion table; and a mail transmission/reception control unit configured to control the transmission and the reception of the mail by comparing a mail address in which the domain of the mail address of the transmitted/received mail is replaced with the original domain acquired by the original domain acquiring control unit with the registered mail address.

With the above configuration, the mail restriction function can be operated effectively without increasing the mail addresses registered for the mail restriction function.

### BRIEF DESCRIPTION OF THE DRAWINGS

In the accompanying drawings:

FIG. 1 is a block diagram illustrating a communication terminal device according to an embodiment of the present invention;

FIG. 2 is a flowchart illustrating a process of setting the restriction mode in the communication terminal device illustrated in FIG. 10;

FIG. 3A to FIG. 3D are views illustrating an example of a control screen used for the process of setting the restriction mode illustrated in FIG. 2;

FIG. 4A to FIG. 4D are views illustrating an example of a control screen used for the process of setting the restriction mode illustrated in FIG. 2;

FIG. 5A to FIG. 5D are views illustrating setting processes of the case that mail transmission and reception in an E-mail is restricted only to be permitted for previously registered members;

FIG. 6A to FIG. 6D are views illustrating setting processes of the case that mail transmission and reception in the E-mail is restricted only to be permitted for mail addresses stored in an address book;

FIG. 7 is a flowchart illustrating a setting removing process of the restriction mode in the communication terminal device illustrated in FIG. 1;

FIG. 8A to FIG. 8D are views illustrating an example of a control screen used in the setting removing process of the restriction mode illustrated in FIG. 7;

FIG. 9 is a flowchart illustrating a mail transmitting process in the communication terminal device illustrated in FIG. 7;

FIG. 10 is a flowchart illustrating in detail a basic domain retrieving process illustrated in FIG. 9;

FIG. 11 is a view illustrating an example of a basic domain table and a plurality of conversion domain tables corresponding to the basic domain table

FIG. 12 is a view illustrating a concrete example of the basic domain table and the domains stored in a plurality of the conversion domain tables 1 to 3 illustrated in FIG. 11 corresponding to the basic domain table;

FIG. 13A to FIG. 13D are views illustrating setting examples of the automatic address converting function;

FIG. 14A to FIG. 14C are views illustrating setting examples of the automatic address converting function;

FIG. 15A to FIG. 15C are views illustrating setting examples of the automatic address converting function.

### DESCRIPTION OF THE PREFERRED EMBDOMENTS

Embodiment of the communication terminal device and its control method according to the present invention will be described in detail with reference to the accompanying drawings.

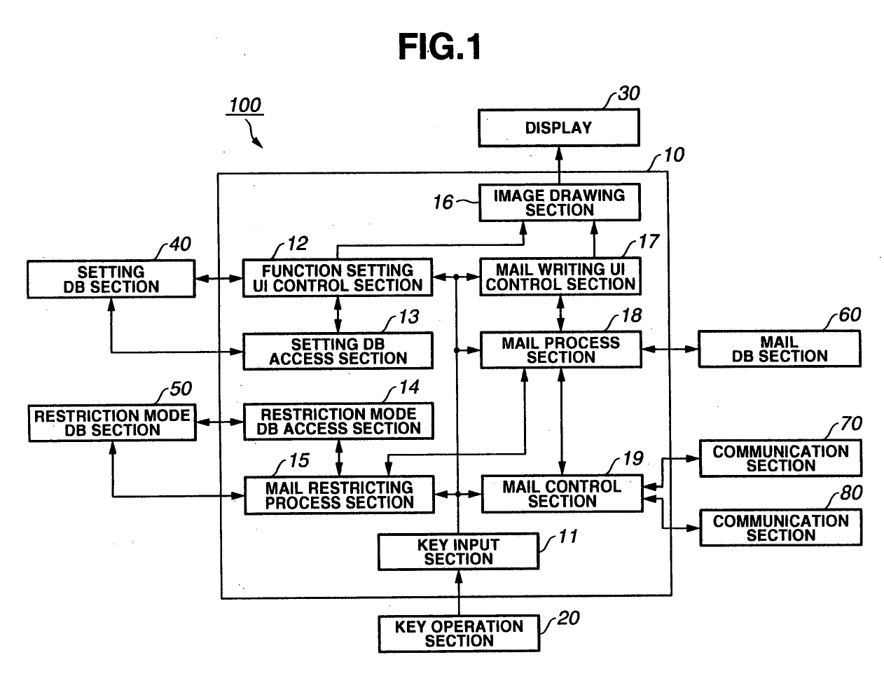

FIG. 1 is a schematic block diagram illustrating the communication terminal device according to the present invention.

This communication terminal device is, for example, a communication terminal device, such as a portable telephone set, having a mail restriction function for permitting transmission and reception of a mail only to a registered mail address, and an automatic address converting function for automatically converting and transmitting/receiving a domain of the mail address of the mail when transmitting and receiving the mail.

The mail restriction function restricts unnecessary transmission and reception of the mail to unintended destination parties, and the automatic address converting function serves to provide various types of service mails, such as a mail/photograph transmitting function for transmitting a mail and photo-mail photograph attached to the mail, a first pictorial letter transmitting function for transmitting a pictorial letter that is displayed in a form suitable for a destination party's terminal when the pictorial letter is displayed in the destination party's terminal, a second pictorial letter transmitting function for transmitting a pictorial letter that is displayed in the same form when the pictorial letter is displayed in the destination party's terminal.

In FIG. 1, this communication terminal device 100 comprises a control section 10, a key operation section 20, a display 30, a setting database section (setting DB section) 40, a restriction mode database section (restriction mode DB section) 50, a mail database section (mail DB section) 60, a communication section 70, and a talking section 80.

The control section 10 comprises a key input section 11, a function setting user interface control section (function setting UI control section) 12, a setting D access section 13, a restriction mode DB access section 14, a mail restricting process section 15, a image drawing section 16, a mail writing user interface control section (mail writing UI controls section) 17, a mail processing section 18, and a main control section 19.

The key operation section 20 has ten keys and various types of function keys, and inputs various types of data and instructions to the communication terminal device 100.

The display 30 displays various types of information regarding operations of the communication terminal device 100.

The setting database section 40 stores setting data of various types of functions, such as a mailing function of the communication terminal device 100.

The restriction mode DB section 50 stores data regarding a restriction mode function of the communication terminal device 100.

The restriction mode is a mode for placing various types of restrictions on the transmission and the reception of a mail and a talk using the communication terminal device 100. Examples of the restrictions are as follows:

1) Mail restriction function for permitting the transmission and the reception of a mail only to parties of the registered mail addresses;

2) Talk restriction function for permitting the talking only to parties of registered telephone numbers;

3) Time zone restriction function for permitting a use only in registered time zones; and

4) Fee restriction function for permitting a use within a registered fee.

The present invention relates to the mail restriction function for permitting the transmission and the reception of a mail only to the registered mail addresses. In this embodiment, only the mail restriction function will be described. In the mail restriction function, mail addresses for permitting the transmission and the reception of a mail are stored in and registered with the restriction mode DB section 50.

The mail DB section 70 stores various types of data regarding a mail function of the communication terminal device 100.

The communication section 80 controls the transmission and the reception of the talking and the mail, and the talking section 90 has a transmitter and a receiver and performs voice talking.

The key input section 11 of the control section 10 processes to receive a key input inputted from the key operation section 20. The function setting UI control section 12 controls setting of various types of functions, such as mail function, mail restriction function, of the communication terminal device 100 based on the data stored in the setting DB section 40. The setting DB access section 13 controls writing and reading of the setting data to the setting DB access section 13.

The restriction mode DB access section 14 controls writing and reading of the setting data to the restriction mode DB section 50. The mail restricting process section 15 realizes the mail restriction function of the communication terminal device 100 based on the data set to the restriction mode DB section 50.

More particularly, in this embodiment, the mail addresses for which the transmission and the reception are permitted are registered previously in the restriction mode DB section 50. The mail restricting process section 50 acquires the mail address of the transmitting/receiving mail from the mail process section 18, and compares the mail address with the mail address registered with the restriction mode DC section 50 to restrict the transmitting/receiving mail.

In this embodiment, to provide a normal mail and various mail services, such as the mail/photograph transmitting function, the first pictorial letter transmitting function, and the second pictorial letter transmitting function, an automatic address converting function is provided for automatically converting the domain of the mail address of the transmitting/receiving mail by the mail process section 18. When the domain of the mail address of a transmitting/receiving mail is automatically converted by the automatic address converting function, the mail restricting process section 15 acquires a mail address including the original domain for judging the mail restriction function from the mail process section instead of acquiring the converted mail address actually using in transmission and reception, and restricts the transmission and reception of the mail by using the mail address for judging the mail restriction function.

The image drawing section 16 processes to form an image to be displayed on the display 30. The mail writing UI control section 17 controls the user interface in writing, editing and processing a mail by using the mail function.

The mail process section 18 controls the writing, editing and processing of the mail using the mail function of the communication terminal device 100 by using the data of the mail DB section 70. The main control section 19 supervises and controls the entire operations of the communication terminal device 100.

The mail process section 18 performs an automatic address conversion process for automatically converting the domain of the mail address of the transmitting/receiving mail corresponding to the using form of the transmitting/receiving mail, thus enabling the use of various types of mail services, such as the mail/photograph transmitting function, the first pictorial letter transmitting function, the second pictorial letter transmitting function in addition to the normal mail service.

This automatic address conversion process is performed based on a basic domain table for storing the domain of a basic address and a plurality of conversion domain tables corresponding to the basic domain table.

The basic domain table and the conversion domain tables will be described in detail later.

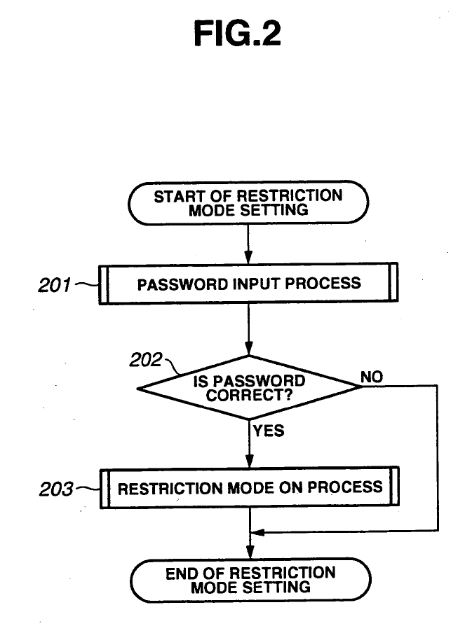

FIG. 2 is a flowchart illustrating a process of setting the restriction mode in the communication terminal device 100 illustrated in FIG. 1.

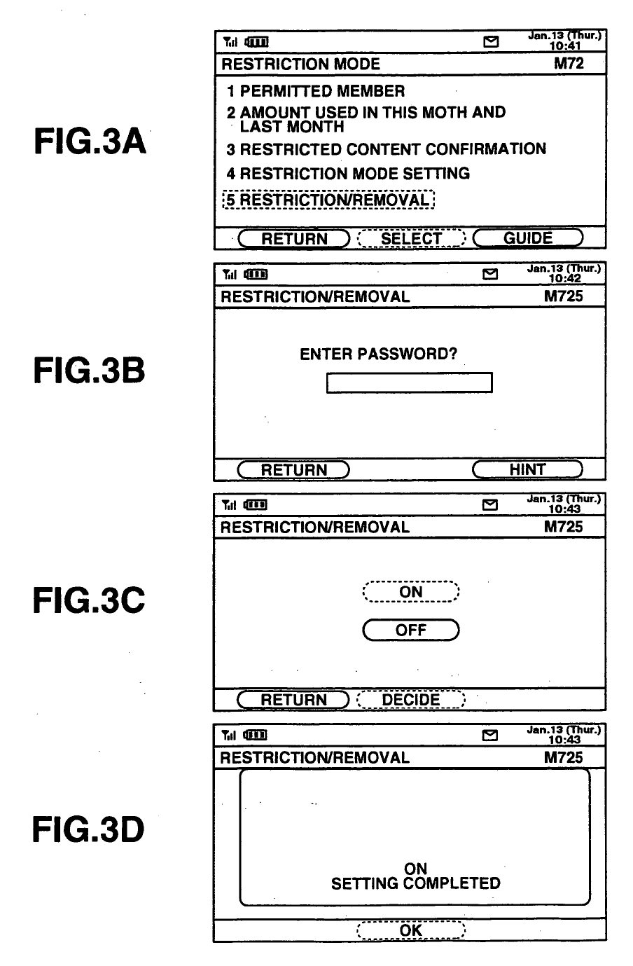

Referring to FIG. 2, the process of setting the restriction mode starts by selecting the restriction mode on a function setting menu screen, not shown, displayed on the display 30 under the control of the function set UI control section 12. When the restriction mode is selected, a menu screen for various types of the restriction mode setting illustrated in FIG. 3A is displayed on the display 30 under the control of the function set UI control section 12.

When “5 restriction/removal” is selected on the menu screen for this restriction mode, a screen for inputting a password for the restricting-removing of the restriction mode illustrated in FIG. 3B is displayed.

When the password is inputted on the screen for inputting password, the input process for the password is performed (step 201), and then judgement is made as to whether the password inputted by the input process is correct or not (step 202).

When the inputted password is not correct (NO in step 202), the process ends without being transferred to the restriction mode.

In step 202, when it is judged that the password is correct (YES in step 202), a restriction mode setting screen for turning on or off of the restriction mode is displayed as illustrated in FIG. 3C.

When “ON” is selected in the restriction mode setting screen, the restriction mode ON process is performed (step 203), a restriction mode confirmation screen showing that the restriction mode is set to ON is displayed as illustrated in FIG. 3D, and the restriction mode setting process ends.

In the restriction mode ON process of step 23, various types of restrictions can be set. Here, in connection with the mail restriction function according to the present invention, the transmission and reception of a mail with respect to the following items will be described.

1) Setting for restriction only to registered permitted members; and

2) Setting for restriction only to the mail addresses stored in the address book.

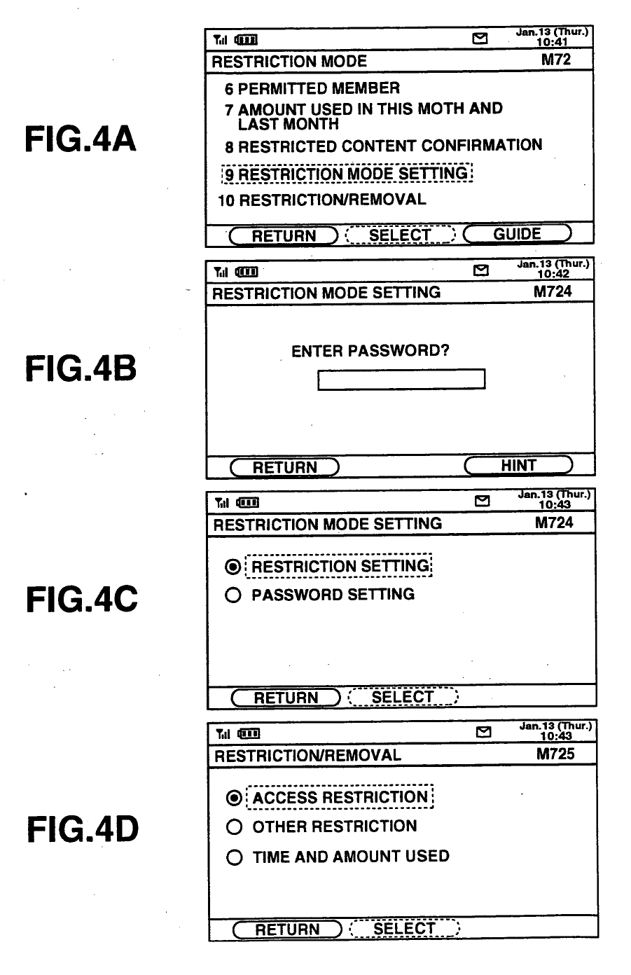

FIGS. 4A through 4D are views illustrating an operation screen used for a process of setting the restriction mode.

When “4 restriction mode set” is selected on a menu screen for the restriction mode as shown in FIG. 4A, a screen for inputting a password of the restriction mode setting is displayed as illustrated in FIG. 4B. When a password is inputted in this input screen for password, and the inputted password is corrected, a screen for selecting either “restriction setting” or “password setting” is displayed as illustrated in FIG. 4C. When the “restriction setting” is selected, a selection screen is displayed as illustrated in FIG. 4D.

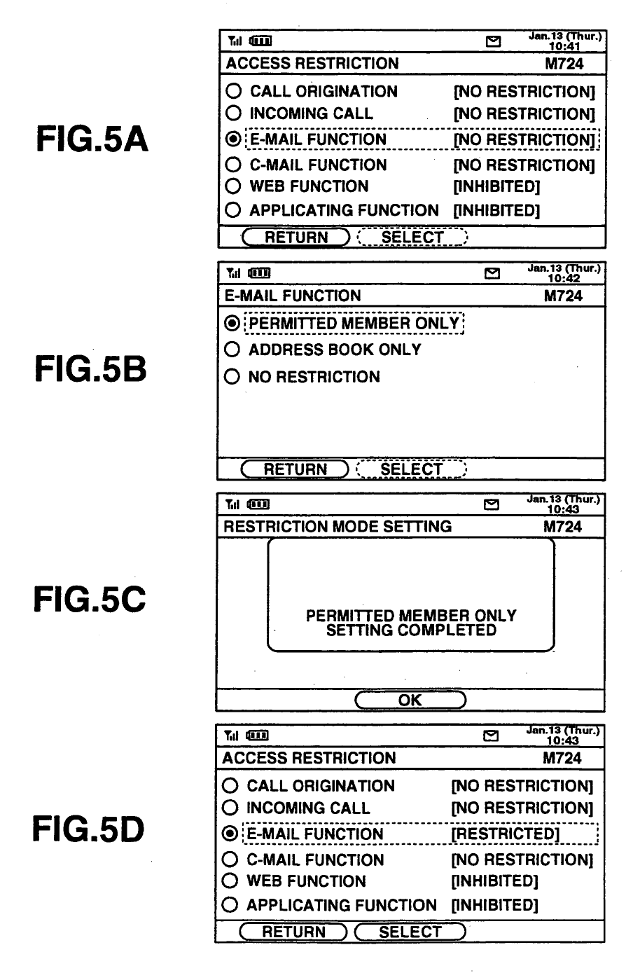

When the “access restriction” is selected, a screen for the setting states of the access restriction is displayed as illustrated in FIG. 5A.

FIGS. 5A through 5D illustrate a setting process when the mail transmitting and receiving in E-mail is restricted only to be permitted for members registered previously.

In a setting list screen of the access restriction illustrated in FIG. 5A, concerning the “E-mail function”, “no restriction” is set.

In the setting list screen of the access restriction, when the “E-mail function” is selected, the selection screen concerning the access restriction of the E-mail illustrated in FIG. 5B is displayed.

When “only permitted member” is selected in the selection screen, the confirmation screen showing that the restriction mode for permitting only the member registered concerning the transmission and the reception of the E-mail illustrated in FIG. 5C is set, is displayed. When “OK” is selected in this confirmation screen, the processing is returned to the setting list screen of the access restriction illustrated in FIG. 5D. Here, concerning the “E-mail function”, it is shown that the “restriction present” is set.

Incidentally, permitted members are registered by inputting information necessary on this registered screen by displaying the registered screen and by selecting the “1 permitted member” on the menu screen of the restriction mode illustrated in FIG. 4A.

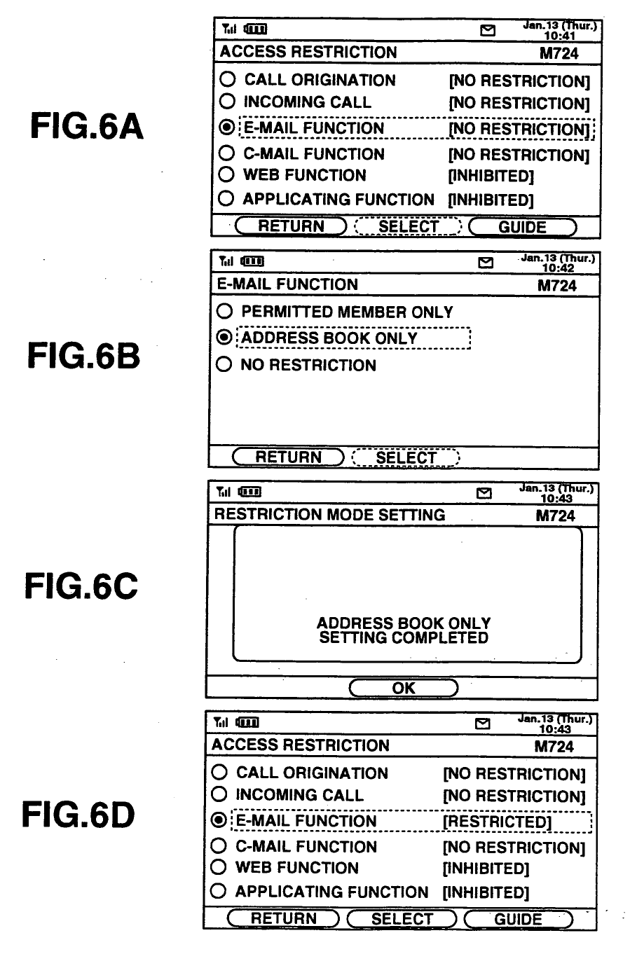

FIG. 6 illustrates a setting process when the transmitting and receiving the mail in the E-mail is restricted only to be permitted for the mail address stored in the address book.

In the setting list screen of the access restriction illustrated in FIG. 6A, concerning the “E-mail function”, “no restriction” is set.

In the setting list screen of this access restriction, when “E-mail function” is selected, the selection screen concerning the access restriction of the E-mail illustrated in FIG. 6B is displayed.

When “address book only” is selected in the selection screen, the confirmation screen showing that the restriction mode set for permitting only the mail address stored in the address book concerning the transmission and the reception of the E-mail illustrated in FIG. 6C is set is displayed. When “OK” is selected in the confirmation screen, the process is returned to the setting list screen of the access restriction illustrated in FIG. 6D. Here, concerning the “E-mail function”, it is shown that the “restriction present” is set.

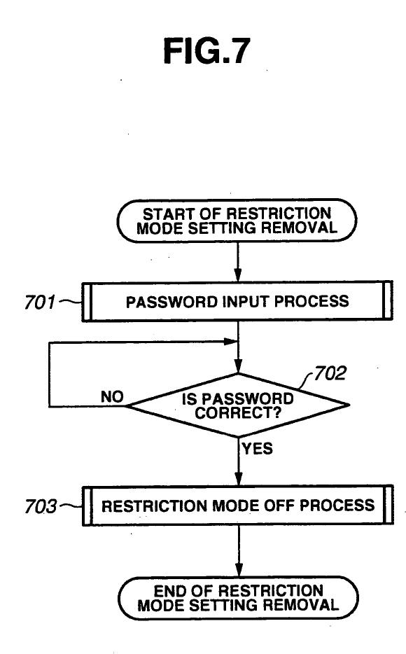

FIG. 7 is a flowchart illustrating a restriction mode setting removal process in the communication terminal device 100 illustrated in FIG. 1.

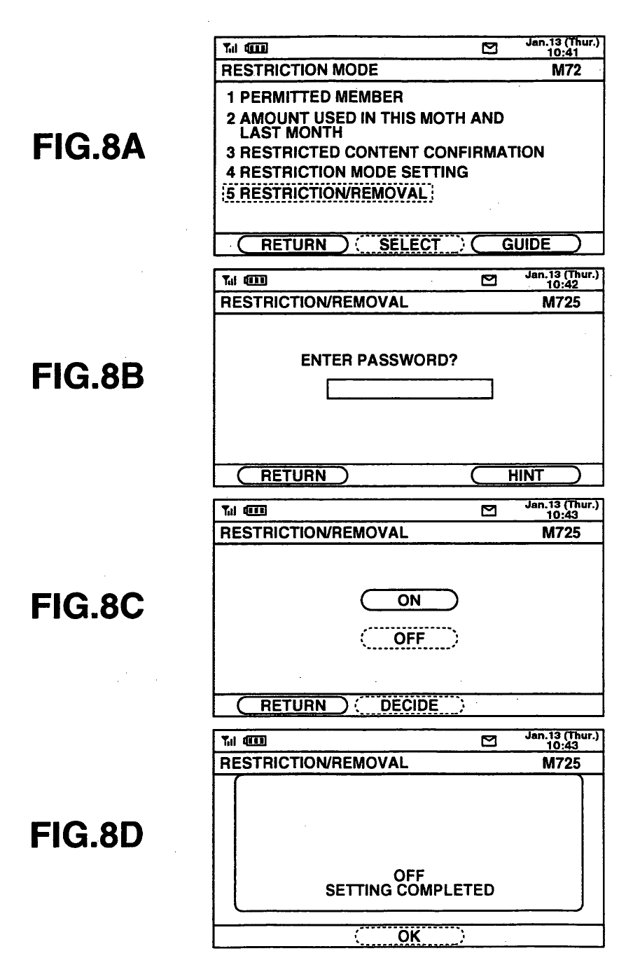

In the restriction mode setting removal process, “5 restriction/removal” is selected on the menu screen of the restriction mode illustrated in FIG. 8A.

The input screen of the password for restricting/removing the restriction mode illustrated in FIG. 8B is displayed by selecting this “5 restriction/removal”.

When the password is inputted in the password input screen, the input process for the inputted password is performed (step 701), and then whether the input password is correct or not is judged by this input process (step 702).

When the password is not correct (NO in step 702), this process is ended without performing the removal of the restriction mode setting.

In the step 702, when it is judged that the password is correct (YES in step 702), a restriction mode setting screen of whether the restriction mode illustrated in FIG. 8C is turned on or off is displayed.

When “OFF” is selected in the restriction mode setting screen, a restriction mode OFF process is performed (step 703), a restriction mode conformation screen showing that the restriction mode illustrated in FIG. 8D is set to OFF is displayed, and the restriction mode setting removal process is ended.

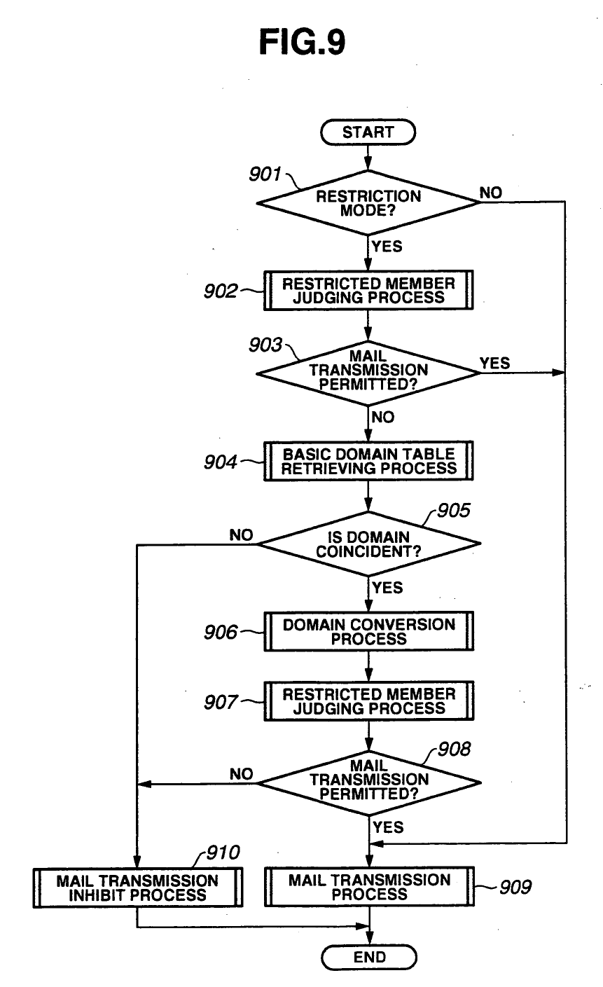

FIG. 9 is a flowchart illustrating a mail transmission process in the communication terminal device 100 illustrated in FIG. 1.

In FIG. 9, when this process starts, first it is checked whether the restriction mode is set concerning the mail transmission or not (step 901). If the restriction mode is not set (NO in step 901), there is no restriction concerning this mail transmission. Therefore, it is advanced to step 909, the transmission process of this mail is performed, and this process is ended.

In step 901, when it is judged that the restriction mode concerning the mail transmission is set (YES in step 901), the restricted member judging process for the transmission destination of this mail is performed (step 902).

In the restricted member judging process, the mail address of the destination for this mail is extracted. When the mail transmission and reception are set to restrict only to the previously registered permitted member, it is judged whether this destination mail address coincides with the mail address of the previously registered permitted member or not. If permission of the mail transmission and reception are set to restrict only to the mail address stored in the address book, it is judged whether this destination mail address coincides with the mail address stored in the address book or not

When the permission of the mail transmission is judged according to the fact whether this destination mail address coincides with the mail address of the previously registered permitted member or coincides with the mail address stored in the address book (YES in step 903), it is judged in this case that the mail transmission is permitted by the normal mail restriction function. Thus, the process is advanced to step 909 where this mail transmission process is performed and then this process is ended.

In the step 903, when it is judged that a mail transmission is not permitted (NO in step 903), a retrieval of the basic domain table that stores the domain of the mail address permitted for the communication with this communication terminal device 100 is performed while considering that the automatic conversion of the domain of the mail address of the destination has been performed by the automatic address converting function (step 903).

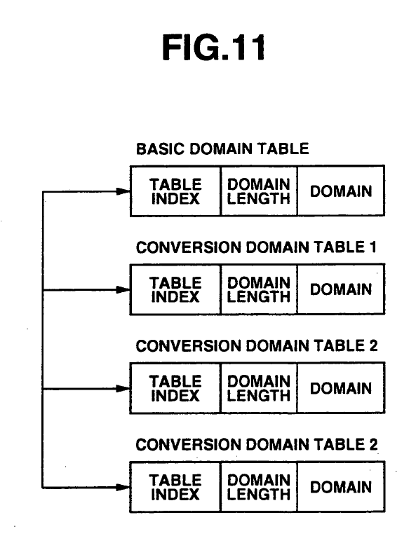

More particularly, in this embodiment, to provide, in addition to the normal mail service, various types of mail services, such as the mail/photograph transmitting function, the first pictorial letter transmitting function, the second pictorial letter transmitting function, the embodiment has the automatic address converting function for automatically converting and transmitting/receiving the domain of the mail address of the mail in the case of transmitting and receiving the mail. This automatic address converting function is performed based on the basic domain table and the plurality of the conversion domain tables corresponding to the basic domain tables, as illustrated in FIG. 11.

As illustrated in FIG. 11, the basic domain table and the plurality of the conversion domain tables 1 to 3 corresponding to the basic domain table respectively have data of “table INDEX”, “domain length”, and “domain”. The basic domain table stores the domain of the mail address for permitting the transmission and the reception of the mail by this communication terminal device, the conversion domain tables 1 to 3 store the domain of the mail address for converting based on the automatic address conversion function, and related to the domain for storing in the basic domain table and the domains for storing in the conversion domain tables 1 to 3.

Therefore, in this automatic address conversion function, for example, to provide the mail address having the domain stored in the basic domain table for the various types of services, the domain of this mail address is replaced with the corresponding domain stored in the conversion domain tables 1 to 3, and address conversion is thereby performed.

However, even if the mail address of the domain stored in the basic domain table is permitted to be transmitted by the mail restriction function, when the domain is automatically changed by the above-mentioned automatic address converting function, the transmission becomes impossible, and the transmission cannot be performed.

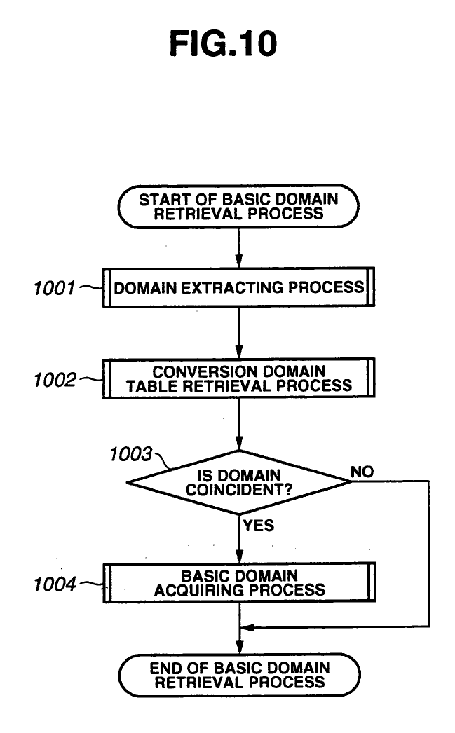

Therefore, in the basic domain table retrieving process of the step 903 as illustrated in FIG. 10, first, the domain is extracted from the mail address of the transmitting mail (step 1001), then a retrieval process of the conversion domain tables 1 to 3 is performed by the extracted domain (step 1002). Thereafter, it is check whether the domains stored in the conversion domain tables 1 to 3 coincide with the extracted domain or not (step 1003). If it is coincident (YES in step 1003), a basic domain acquiring process for acquiring the domain stored in the basic domain table corresponding to the coincident domain is performed (step 1004), and ends the basic domain table retrieval process.

In the step 1003, if the domain extracted from the mail address of the transmission mail does not coincide with any of the domains stored in the conversion domain tables 1 to 3 (NO in step 1003), the basic domain table retrieval process is ended.

When it is judged that the domain extracted from the mail address of the transmission mail is coincident with any of the domains stored in the conversion domain tables 1 to 3 in the basic domain table retrieval process of the step 904 (YES in step 905), the domain conversion process is performed (step 906).

This domain conversion process is performed by the process for replacing the domain of the mail address of the transmission mail with the basic domain acquired by the basic domain acquirement process of the step of FIG. 10.

In this domain conversion process, the restricted member judging process is again performed based on the domain converted mail address (step 907).

This restricted member judging process is the same as the restricted member judging process of the step 902 except that the domain of the mail address to be processed of the restricted member judging process is replaced with the basic domain.

When the mail transmission permission is judged by the restricted member judging process of this step 907 (YES in step 908), the process is advanced to the step 909, in which the transmission process of this mail is performed, and this process is ended.

In step 905, when it is judged that the domain extracted from the mail address of the transmission mail does not coincide with any of the domains stored in the conversion domain tables 1 to 3 (NO in step 905), or judged that transmission is not permitted in the step 908 (NO in step 908), the transmission inhibit process of this mail is performed (step 910), and this process is ended.

More particularly, in this process, if the mail address of the transmission mail coincides with the mail address of the previously registered permitted member or the mail address stored in the address book, the transmission of this mail is permitted by the normal mail restriction function. However, if the mail address of this transmission mail does not coincide with the mail address of the previously registered permitted member or the mail address stored in the address book, the domain before the conversion is retrieved while considering that there may be the case that the domain of the mail address is automatically converted by the automatic address conversion function, the domain of the mail address of the transmission mail is replaced with the domain before the conversion, the transmission permission of this mail is again judged by the mail address replaced at this domain.

Thus, if even the mail transmission of which would not be permitted due to the mail restriction function by the automatic address conversion function is permitted to be transmitted by the mail restriction function, the transmission of this mail is permitted. Incidentally, although the flowchart of FIG. 9 explains the mail transmission process is described, the flowchart can be applied in the case of mail reception process.

More particularly, the automatic address converting function is provided for various types of mail services, such as the mail/photograph transmitting function, the first pictorial letter transmitting function, the second pictorial letter transmitting function in addition to the normal mail. Therefore, even if the domain of the mail address is automatically changed, the automatic address converting function enables to transmit the mail to the same destination party.

There may be a problem in which, when this automatic address conversion function is operated, a mail cannot be transmitted by the normal mail restriction function although the mail is for the same destination party. With the above-described configuration, however, this problem can be eliminated.

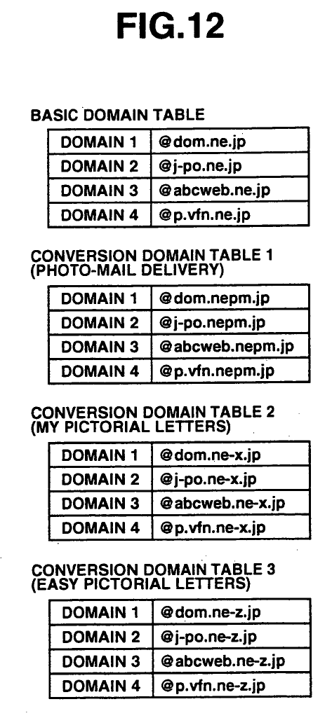

FIG. 12 illustrates an example of domains stored in the basic domain table and in plural conversion domain tables 1 to 3 corresponding to the basic domain table illustrated in FIG. 11.

Referring to FIG. 12, in the basic domain table, the basic domain used for the basic service provided by a plurality of communication companies which can transmit and receive the mail by this communication terminal device. The conversion domain table 1 stores the domain used when the mail/photograph transmitting function is used, corresponding to the basic domain stored in the basic domain table. The conversion domain table 2 stores the domain used when the first pictorial letter transmitting function corresponding to the basic domain stored in the basic domain table, and the third conversion domain table 3 stores the domain used when the second pictorial letter transmitting function corresponding to the basic domain stored in the basic domain table.

Therefore, when the photo-mail delivery is used, for example, the basic domain of the mail address of the transmission mail is automatically converted into a domain that is stored in the conversion domain table 1 corresponding to the basic domain by the automatic address conversion function, and this mail is transmitted to the destination party by the mail address having the converted domain.

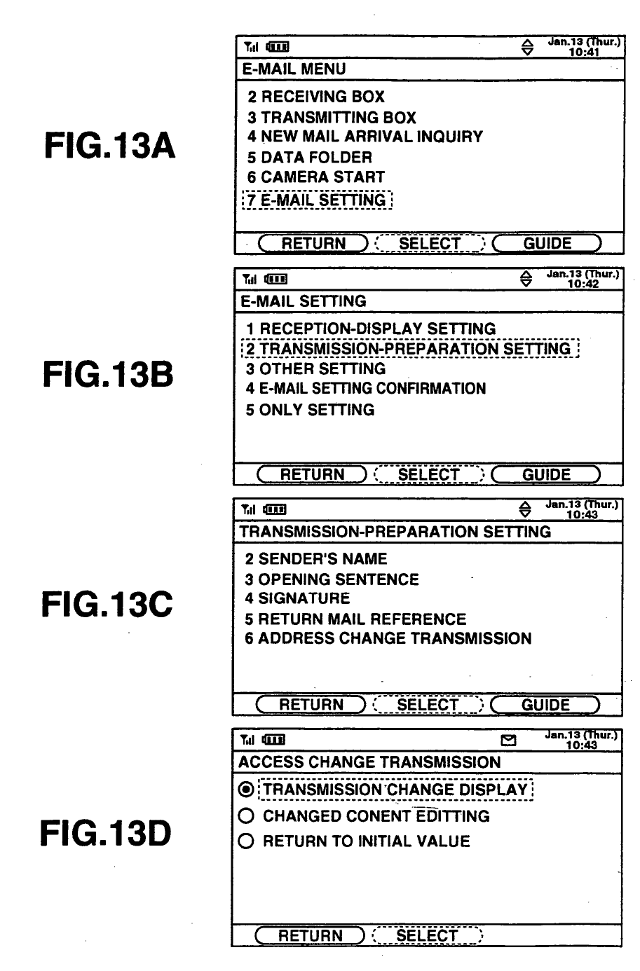

FIG. 13 to FIG. 15 illustrate examples of the setting for the automatic address conversion function.

In FIG. 13, in setting the automatic address conversion function, first “7 E mail setting” is selected in the E-mail menu shown in FIG. 13A.

Then, E-mail set menu screen illustrated in FIG. 13B is displayed by the E-mail setting. When “2 transmitting-preparation setting” is selected on the E-mail setting menu screen, the menu screen of the transmitting-preparation setting is displayed as illustrated in FIG. 13C.

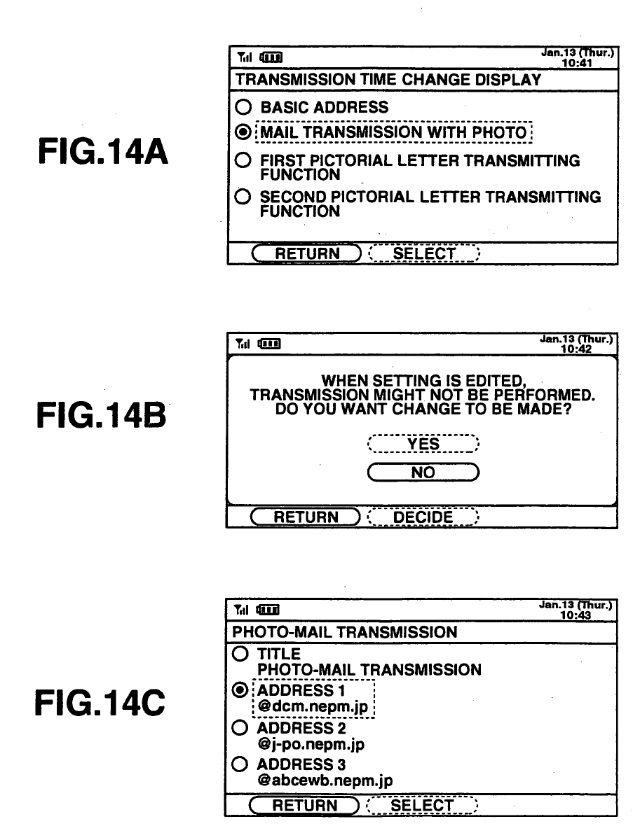

When “6 address change transmission” is selected on the menu screen of the transmitting-preparation setting, the selection screen for the address change transmission illustrated is displayed as illustrated in FIG. 13D. When “transmitting time change display” is selected on the selection screen for the address change transmission, the selection screen for the transmitting time change display is displayed illustrated in FIG. 14A.

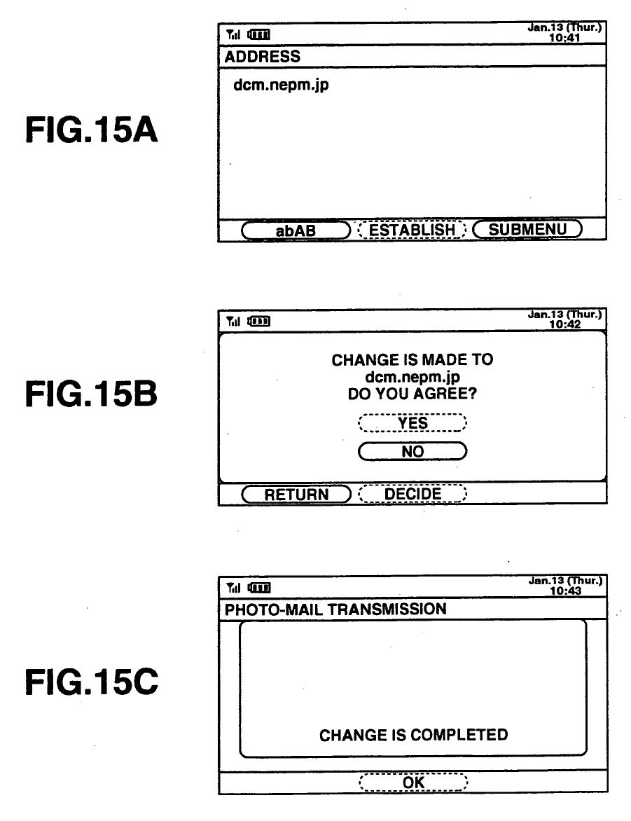

When “mail transmitting with photo” is selected, a notice screen of “when setting is edited, transmission might not be performed. Do you want change to be made?” is displayed as illustrated in FIG. 14B. Here, when “YES” is selected, a list of the domains used in the mailing function with the photograph is displayed. When “@dcm.nepm.jp” of an address 1 is selected, the domain “dcm.nepm.jp” is displayed as illustrated in FIG. 15A.

When this is established, a confirmation screen of whether you agree the domain whose address is automatic converted when the mail/photograph transmitting function is used is “dcm.nepm.jp” or not is displayed as illustrated in FIG. 15B. When “YES” is selected, the setting confirmation screen in which the domain is changed so that the address is automatically converted when the mail/photograph transmitting function is used, is displayed.

Although FIG. 13 to FIG. 15 illustrate an example of domain setting in which the address is automatically converted when the service of the mail transmitting function is used, domain setting in which the address is automatically converted for the cases in which the service of the first pictorial letter transmitting function, the service of the second pictorial letter transmitting function, or other services are used can be similarly performed.

The present invention can be used for the communication terminal device, such as a portable telephone set, having the mail restriction function for permitting the transmission and the reception of the mail only to the registered mail address and the automatic address converting function for automatically converting and transmitting/receiving the domain of the mail address of the mail in the case of transmitting/receiving the mail.

According to the present invention, the communication terminal device has a configuration in which a domain conversion table that stores a corresponding relationship between an original domain which is a domain before conversion by the automatic address conversion unit and a domain converted by the automatic address conversion unit; an original domain acquiring unit that acquires the original domain based on the domain of the mail address converted by the automatic address conversion unit by referring to the domain conversion table; and a mail transmission/reception control unit that controls the transmission and the reception of the mail by comparing a mail address in which the domain of the mail address of the transmitted/received mail is replaced with the original domain acquired by the original domain acquiring unit with the registered mail address.

What is claimed is:

1. A communication terminal device comprising:
a mail restricting control unit configured to permit transmission and reception of a mail having a registered mail address;
an address conversion control unit configured to convert a domain of a mail address of a mail;
a domain conversion table configured to store a corresponding relationship between an original domain which is a domain before conversion by the address conversion control unit and a domain converted by the address conversion unit;
an original domain acquiring control unit configured to acquire the original domain based on the domain of the mail address converted by the address conversion control unit by referring to the domain conversion table; and
a mail transmission/reception control unit configured to control the transmission and the reception of the mail by comparing a mail address in which the domain of the mail address of the transmitted/received mail is replaced with the original domain acquired by the original domain acquiring control unit with the registered mail address.

2. The communication terminal device according to claim 1, wherein the mail transmission/reception control unit compares the mail address in which the domain of the mail address of the transmitted/received mail is replaced with the original domain acquired by the original domain acquiring control unit with a mail address previously registered in a list of permitted members, and permits the transmission and the reception of the mail only if the mail addresses are coincident with each other.

3. The communication terminal device according to claim 1, wherein the mail transmission/reception control unit compares the mail address in which the domain of the mail address of the transmitted/received mail is replaced with the original domain acquired by the original domain acquiring control unit with a mail address previously registered in an address book, and permits the transmission and the reception of the mail only if the mail addresses are coincident with each other.

4. The communication terminal device according to claim 1, wherein the domain conversion table comprises:
a basic domain table that stores the domain of the basic mail address; and
one or a plurality of conversion domain tables that stores a conversion domain corresponding to the domain stored in the basic domain storage table, and
the original domain acquiring control unit discriminates the domain stored in the basic domain table in correspondence with the conversion domain stored in the conversion domain table converted by the address conversion control unit as the original domain.

5. The communication terminal device according to claim 1, wherein the mail transmission/reception control unit comprises:
a transmission and reception judging mail address generating unit that generates the mail address in which the domain of the mail address of the transmitted/received mail is replaced with the original domain acquired by the original domain acquiring control unit as a transmission and reception judging mail address;
a comparing unit that compares the transmitting and receiving judging mail address generated by the transmission and reception judging mail address generating unit with the registered mail address; and
a mail transmission and reception restricting unit that restricts the transmission and the reception of the transmitted and received mail based on a result of the comparing unit.

6. The communication terminal device according to claim 1, wherein
the address converting control unit converts the domain of the mail address of the transmission and reception mail corresponding to a type of the transmission and reception mail.

7. A method for controlling a communication terminal device having a mail restricting unit that permits transmission and reception of only a mail having a registered mail address; and an automatic address conversion unit that automatically converts a domain of a mail address of a mail, and transmits or receives the mail, comprising:
storing in a domain conversion table a corresponding relationship between an original domain which is a domain before conversion by the automatic address conversion unit and a domain converted by the automatic address conversion unit;
acquiring by an original domain acquiring unit the original domain based on the domain of the mail address converted by the automatic address conversion unit by referring to the domain conversion table; and
controlling by a mail transmission/reception control unit the transmission and the reception of the mail by comparing a mail address in which the domain of the mail address of the transmitted/received mail is replaced with the original domain acquired by the original domain acquiring unit with the registered mail address.
